(19) United States
(12) Patent Application Publication
(10) Pub. No.: US 2026/0102710 A1
(43) Pub. Date: Apr. 16, 2026

(54) GENERATING & MODIFYING IN-GAME CONTENT BASED ON REAL-WORLD ACTIONS

(71) Applicant: SONY INTERACTIVE ENTERTAINMENT LLC, SAN MATEO, CA (US)

(72) Inventor: Melissa Soucie, San Mateo, CA (US)

(21) Appl. No.: 18/913,079

(22) Filed: Oct. 11, 2024

(51) Int. Cl. A63F 13/65

(52) U.S. Cl. CPC A63F 13/65

(57) ABSTRACT

Systems and method for systems and method for generating and modifying in-game content based on real-world interactions are provided. A physical collectible item may include an embedded code associated with a user account used during interactive gameplay sessions. The user may engage in various real-world activities in real-world environments, and data regarding such real-world engagement may be tracked in association with the embedded code. The engagement data may be used to generate new or modified digital content to present during or in association with a next interactive gameplay session. The new or modified digital content may include digital rewards or trophies, as well as modifications to in-game parameters such as appearance or abilities of avatar(s) associated with the user.

### BACKGROUND OF THE INVENTION

### 1. Field of the Invention

The present invention generally relates to generating and modifying in-game content. More specifically, the present invention relates to generating and modifying in-game content based on real-world interactions.

### 2. Description of the Related Art

Presently available digital interactive content allow a user to interact with digital or virtual characters and objects—which may or may not be controlled by other users—within digital environments during interactive (e.g., gameplay) sessions. For example, during gameplay of a video game title, a player may control and direct an avatar to interact with other avatars and perform various actions, which may contribute towards achieving game objectives and thus earning in-game rewards. Such objectives and rewards are generally governed by the particular game title being played.

The virtual actions and interactions associated with a user and/or their respective avatar may be tracked by their respective user device, game servers, platform servers, or associated device having access to the virtual environment. Such devices may monitor the controlled, digital environment and thus be able to detect user inputs resulting in changed progress levels being made towards in-game rewards and achievements. There are a variety of challenges, however, in extending the game experience into real-world engagement in real-world settings. One challenge is the ability to monitor real-world environments and characterize user actions accurately. While some portable games allow users to engage in gameplay on the go, portable gameplay—in which a user plays the same or similar game using a portable device—is distinct from using real-world actions and interactions (e.g., with real world peers, objects, locations, etc.) to earn or otherwise obtain virtual rewards.

Further, an avatar may be imbued with a variety of different abilities, both realistic or fantastic, and thus able to perform actions that a user may not be able to do in real-world settings. For example, an avatar may have the ability to fly through walls, teleport, become invisible, shoot lasers from their eyes, etc. Moreover, some game titles allow avatars to act in ways that may be inappropriate, illegal, or otherwise result in significant adverse consequences in the real-world, such as stealing automobiles and crashing into objects. Such game experiences and themes may thus be difficult to extend into real-world settings. Engagement with various digital media titles are thus generally limited to virtual environments.

There is, therefore, a need in the art for improved systems and methods for generating and modifying in-game content based on real-world interactions.

### SUMMARY OF THE CLAIMED INVENTION

Embodiments of the present invention include systems and method for generating and modifying in-game content based on real-world interactions. A physical collectible item may include an embedded code associated with a user account used during interactive gameplay sessions. The user may engage in various real-world activities in real-world environments, and data regarding such real-world engagement may be tracked in association with the embedded code. The engagement data may be used to generate new or modified digital content to present during or in association with a next interactive gameplay session. The new or modified digital content may include digital rewards or trophies, as well as modifications to in-game parameters such as appearance or abilities of avatar(s) associated with the user.

### BRIEF DESCRIPTION OF THE DRAWINGS

FIG. 1 illustrates an exemplary network environment in which a system for generating and modifying in-game content based on real-world interactions may be implemented.

FIGS. 2A-C illustrate exemplary physical collectible items that may be used to track real-world interactions that are the bases for generating and modifying in-game content.

FIG. 3 illustrates an exemplary kiosk where physical collectible items may be obtained and registered with user accounts.

FIGS. 4A-F illustrate exemplary screenshots of graphical user interfaces (GUIs) that may be presented on a user device as real-world interactions are tracked for generating and modifying in-game content.

FIG. 5 is a diagram illustrating an exemplary implementation of a system for generating and modifying in-game content based on real-world interactions.

FIG. 6 illustrates an exemplary reward of digital content provided within a digital environment.

FIG. 7 illustrates an exemplary update to digital content provided from a digital environment.

FIG. 8 is a flowchart illustrating an exemplary method for generating and modifying in-game content based on real-world interactions.

FIG. 9 is a block diagram of an exemplary electronic entertainment system for implementing aspects of the present disclosure.

### DETAILED DESCRIPTION

Embodiments of the present invention include systems and method for generating and modifying in-game content based on real-world interactions. A physical collectible item may include an embedded code associated with a user account used during interactive gameplay sessions. The user may engage in various real-world activities in real-world environments, and data regarding such real-world engagement may be tracked in association with the embedded code. The engagement data may be used to generate new or modified digital content to present during or in association with a next interactive gameplay session. The new or modified digital content may include digital rewards or trophies, as well as modifications to in-game parameters such as appearance or abilities of avatar(s) associated with the user.

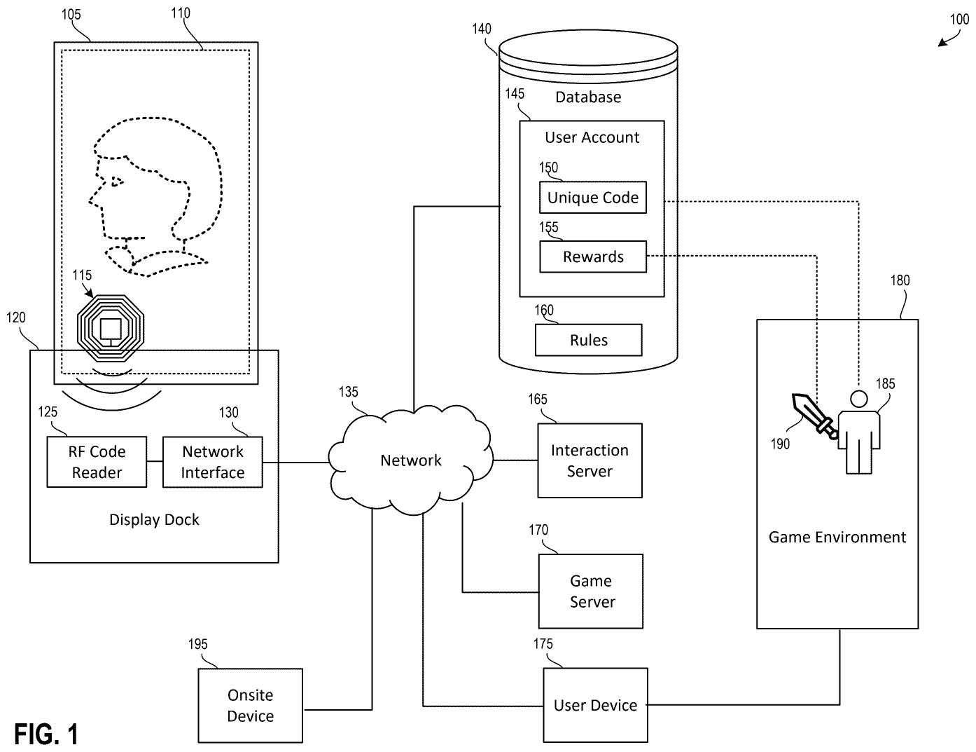

FIG. 1 illustrates an exemplary network environment 100 in which a system for generating and modifying in-game content based on real-world interactions may be implemented. Network environment 100 may include a physical collectible item 105 (e.g., card displaying content 110 and including an embedded code 115), display dock 120 (including code reader 125 and network interface 130), communication network 135, database 140 (storing a user account 145 associated with unique code 150 and digital rewards 155, as well as rules 160), interaction server 165, game server 170, user device 175 used to generate a game environment 180 that includes an avatar 185 and in-game object 190 based on data from user account 145 and digital rewards 155, and onsite device 195. Devices in network environment 100 may communicate with each other via communications network 135.

As illustrated, physical collectible item 105 may be shaped as a card constructed of any suitable material (e.g., paper-based materials, metal, plastic). A variety of other physical objects may be used, however, within the scope of the present disclosure that are not limited to the form factor of a card. For example, the physic physical collectible item 105 may include an action figure, a model, or any other portable physical object that is capable of presenting an embedded code to code readers (e.g., code reader 125). For ease of description, the physical object will be described hereafter as a physical collectible item 105, recognizing that the term can be more broadly construed.

In some embodiments, the physical collectible item 105 may be printed with or otherwise display content 110 (e.g., artwork) on the surface of the physical collectible item 105. The content 110 may be associated with a particular video game or other content title (e.g., a specific character, faction, location, scene, and/or item from the video game). In some embodiments, a set of cards 105 may be associated with a particular video game or gaming franchise. In certain implementations, the content 110 may be selected and/or provided by a purchaser of the physical collectible item 105.

The content 110 may be applied to the physical collectible item 105 using one or more of a variety of technologies, e.g., digital printing, which uses inkjet technology to create high-quality images directly on plastic; laser printing, which uses a high-powered laser to etch a design into the plastic; screen printing, which uses a stencil or mesh screen to transfer ink onto the plastic; UV litho printing, which uses ultraviolet light to cure or dry ink on a variety of surfaces; pad printing, which uses a silicone pad to transfer ink from an etched plate onto a 2D surface or 3D plastic object; flexo printing, which uses flexible photopolymer print forms for direct printing; and/or offset printing, which can produce high-quality prints on plastic and other substrates.

In some embodiments, the physical collectible item 105 includes a embedded code 115 (such as a QR code, bar code, or other code) printed on the surface of the physical collectible item 105 using a technique similar to or different from the content 110, encoded in an radio frequency identification (RFID) chip, NFC tag, Bluetooth® tag, or otherwise.

The physical collectible item 105 may be inserted into a handheld accessory, such as a display dock 120, which securely holds and displays the physical collectible item 105. The display dock 120 may include a code reader 206, which is capable of reading the embedded code 115 from the physical collectible item 105. For example, if the embedded code 115 is encoded into a radio frequency identification (RFID) tag, the code reader 125 may be an RFID reader, while if the embedded code 115 is a NFC or Bluetooth® tag, the code reader 125 may be an NFC or Bluetooth® tag reader, respectively. In some implementations, the display dock 120 may be part of or connectable to a portable user device 175, such as a smartphone or tablet. The smartphone or tablet may read the embedded code 115 using a built-in camera or NFC or Bluetooth® reader. The embedded code 115 may then be sent to the interaction server 160 via a cellular network and/or the Internet in the manner described above.

The code reader 125 may provide the embedded code 115 to a network interface 130, which is capable of sending the unique code to a interaction server 160 through communication network 135, including the Internet. The network interface 130 may implement any suitable protocol(s), e.g., IEEE 802.11x, LTE, TCP/IP. The interaction server 160 may then look up the embedded code 115 to identify a user account 145 stored in association with a matching unique code 150 in database 140. The user account 145 and/or database 140 may be associated with a gaming network, such as the PlayStation Network™ (PSN). In some configurations, the database 140 may be implemented using blockchain technology.

Communication network 135 may be a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 135 allows for communication between the various components of network environment 100.

Database 140 may be inclusive of local storage or storage distributed across multiple different servers, or on any of the devices (e.g., interaction server 165, game server 170, user device 175) in network environment 100. Database 140 may store data associated with a user account 145, including information about the user (e.g., user progress in an interactive online activity and/or media content title, user id, associated avatars and game characters, etc.) that may be associated with one or more media titles and engagement thereof over communication network 135. As illustrated, user account 145 may further be associated with a stored unique code 145 and information regarding digital rewards 155 earned by the user or to which the user is otherwise entitled to be access. Database 140 may further store rules 160 governing how real-world interactions may result in new digital rewards 155. Such rules 160 may specify different progress levels or requirements for earning or obtaining one or more of the digital rewards 155. For example, the rules may specify that a real-world interaction in which the user seeks out and scans a code affixed to a real-world object (e.g., sword or jewel prop) within a real-world environment may earn the user one type or amount of reward, while further real-world actions (e.g., swinging the sword prop, saying a predetermined magic word to the jewel, finding an individual role-playing a particular character) may earn more or different rewards.

Each rule 160 may thus correspond to a real-world action associated with winning or obtaining a reward 155. The real-world action may be defined by one or more parameters, so determining whether the requirements are met entails evaluating an interaction signal to see whether it provides parameters that match those specified by the rule 160. For example, rule 160 may require an image or photo of a real-world object, and thus the interaction signal may provide image data that matches stored data regarding images of the real-world object. The real-world action may also include actions involving images, scans, or signals associated with or characterizing specific geographic locations, individuals, movements, or content.

Rule 160 may also specify a predetermined maximum number of times that a reward 155 may be issued to users. Limiting the number of digital rewards may increase exclusivity of access or usage of the content associated with the digital reward in virtual environments. As such, meeting the requirements of the rule 160 may include determining whether the predetermined maximum has been met previously. Once the maximum is met, no further copies of that specific digital reward may be provided to user accounts.

Such data in database 140 may be continually updated as a user continues to engage in new online interactive sessions and produce new session data regarding various interactions that have taken place within digital environments. In addition, database 140 may be updated based on real-world interactions that are associated with the embedded code 115, which may then be matched to the stored unique code 150. Such updates may also include updated rewards 155 that accrue to the user account 145 when the real-world interactions are determined to have occurred.

Digital rewards may include digital artwork, digital trophies or badges, custom skins applicable to in-game characters or objects, in-game abilities, mini-games, etc. In some implementations, a digital reward may be combined or stacked with pre-existing content associated with the user account 145 (e.g., played game titles, avatars, in-game objects, previously earned digital rewards) to result in custom combinations based on the user's current rewards. In some instances, there may be a collection of digital rewards available to be won, and the newly-obtained digital reward may be added to a current collection. Some digital rewards may correspond to different components of an in-game object where a certain number or type may be required to use the in-game object or to exercise certain abilities of the in-game object. Digital rewards 155 may also include new or modified in-game abilities, which may be specific to certain avatar(s) and/or certain game titles.

The content associated with the digital reward may further be based on user data, so that the content generated for one user (e.g., of particular age, demographic, game history, account level) that performed a real-world action may be different than content generated for another user that performed the same real-world action. The user may further provide customization input to further customize the digital content, including incorporating added or modified content, such as adding their names, user names, graphics, configurations, etc.

Network environment 100 may further include one or more interaction servers 165 and game servers 170. The servers described herein may include any type of server as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

Interaction server 165 may include any data server known in the art that is capable of communicating over communication network 135 with the other devices in the network environment 100. Interaction server 165 may be implemented on one or more cloud servers that carry out instructions associated with the methods described herein. Interaction server 165 may further carry out instructions, for example, for matching codes embedded in signals received over communication network 135 to a unique code 150 stored in a particular user account 145 in database 140. The received signals may also be indicative of a real-world interaction to be associated with their user account.

Interaction server 165 may evaluate such indications of real-world interactions in conjunction with rules 160 to determine whether the particular user (associated with user account 145) has satisfied the requirements of one or more rewards. Where interaction server 165 determines that a set of requirements has been satisfied for a particular reward, the interaction server 165 may update the user account 145 to reflect the reward 155 is now available to the user. Such a digital reward or entitlement may be inclusive of newly generated or modified digital content, skins, trophies, in-game resources, in-game abilities or ability enhancements, custom objects, etc. In some configurations, the embedded code 115 may unlock part or all of the digital environment (e.g., video game) itself.

Game server 170 (or interactive content server) may maintain and provide a variety of digital content and digital services (e.g., corresponding to different game titles) available for distribution over communication network 135. The game server 170 may be associated with any content provider that makes its digital content available for access over communication network 135 (e.g., streaming or download). Multiple different game servers 170 may therefore host a variety of different content titles (e.g., different video games), which may further have be associated with object data regarding a digital or virtual character or object displayed in a digital or virtual environment during an interactive session. Such content may include not only digital video and games, but also other types of digital applications and services. Such applications and services may include any variety of different digital content and functionalities that may be provided to user devices 175, including providing and supporting chat and other communication channels. The chat and communication services may be inclusive of voice-based, text-based, and video-based messages. Thus, a user device 175 may participate in a gameplay session concurrent with one or more communication sessions, and the gameplay and communication sessions may be hosted on the same or different game servers 170. In some implementations, game server 170 may communicate with database 140 in order to obtain information regarding specific users of user accounts 145 and to tailor in-game interactions to a specific user or sets of users in accordance with the user-specific data.

Users may use any number of different electronic user devices 175, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network 135. User devices 175 may also be configured to access data from other storage media, such as memory cards or disk drives as may be appropriate in the case of downloaded services. User device 175 may include standard hardware computing components such as network and media interfaces, non-transitory computer-readable storage (memory), and processors for executing instructions that may be stored in memory.

In exemplary embodiments, user device 175 may stream and render interactive digital content from one or more online sources (e.g., game server 170). Thus, a digital, virtual environment such as game environment 180 may be presented to a user of user device 175 (e.g., via display accessory devices or display components). The user may control an avatar 185 within the game environment 180. Such an avatar 185 may be specific to the user and the particular content title being streamed and/or executed by user device 175. Some users may make extensive customizations to their avatar(s) 185, and such customizations may be stored by database 140 in association with the user account 145 of the user. Game server 170 and/or user device 175 may thus access database 140 in order to obtain and process such data for presentation within the game environment 180.

Similarly, in-game objects 190 and abilities and characteristics thereof may be associated with the user account 145 or more specifically, the rewards 155 accrued to the user account 145. For example, the game environment 180 may be a game environment, such as a role-playing game (RPG) title, in which the user is graphically represented by avatar 185. The embedded code 115 may be associated with a real-world action that satisfies the requirements for unlocking a digital reward 155 (e.g., such as an in-game sword or other weapon), which may then be stored to user account 145 and provided to the user's avatar 185 during a next gameplay session. In some embodiments, when the embedded code 115 is associated with the user's account 214, the reward 155 becomes permanently or temporarily unlocked for use by the user within the game environment 180. In other embodiments, the reward 155 is unlocked as long as the physical collectible item 105 is docked, i.e., removal of the physical collectible item 105 from the display dock 120 may remove and/or re-lock the reward 155 for the user within the game environment 180.

Onsite device 195 may include kiosks, scanning devices, or other reading devices located at a specified geographic location. Onsite device 195 may detect, scan, or read the embedded code 115 when the user—carrying the physical collectible item 105—is within range. Conversely, onsite device 195 (and associated code) may be detected by a device carried by the user, such as the physical collectible item 105, display dock 120, or mobile user device 175, which may then formulate interaction signals evidencing user presence within range or proximity. In some embodiments, the associated display dock 120 or user device 175 may also communicate with onsite device 195 to assist with location detection and sharing in accordance with permissions and settings of the user. In some implementations, onsite devices 195 may include any device with location awareness components such as global positioning system (GPS) chips, which may further be used to detect and communication location information along a unique code over communication network 135 to interaction server 165.

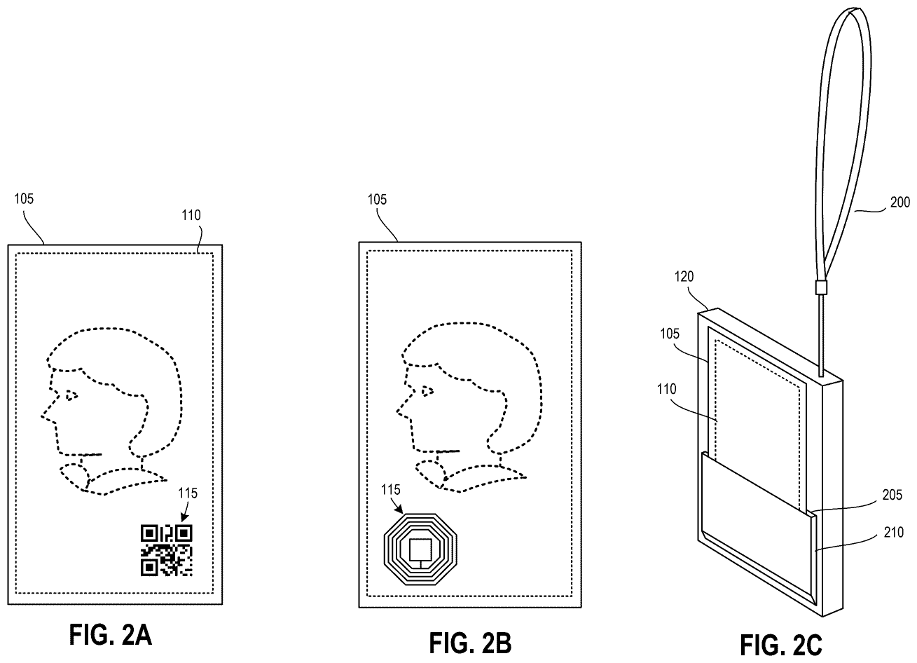

FIGS. 2A-C illustrate exemplary physical collectible items 105 that may be used to track user engagement across real-world and digital environments. As shown in FIG. 2A, the embedded code 115 may be printed in the form of a quick response (QR) code, which is a type of two-dimensional matrix barcode. However, any kind of human-readable text or machine-readable barcode may be used to represent the embedded code 115 on the physical collectible item 105. In some embodiments, the unique code may be a GUID (globally unique identifier), which is a 128-bit text string that can uniquely identify the physical collectible item 105. The embedded code 115 may include a unique code that may be matched to a user account 145 (of FIG. 1) of a specific user (e.g., the owner or bearer of the physical collectible item 105).

Alternatively, as shown in FIG. 2B, the embedded code 115 may be embedded or stored within a radio frequency tag, such as a radio frequency identification (RFID) tag. RFID tags are small devices that use radio waves to identify, track, and communicate with objects. They can store a variety of information, such as serial numbers, short descriptions, and other data. Some RFID tags also have cryptographic security features for authentication and verification. The RFID tag may include a memory device to store the embedded code 115, as well as an antenna for communicating with and/or receiving power from a reader device. A variety of technologies besides RFID may be used, such as near field communication (NFC) and/or Bluetooth.

FIG. 2C illustrates an implementation in which the physical collectible item 105 may be inserted and carried within a portable display dock 120, which additionally includes a strap 200 or lanyard for easy carrying and a slot 205 into which the physical collectible item 105 may be inserted into a receptacle 210. The slot 205 and/or the receptacle 210 are configured (e.g., provided suitable length, width, depth, materials, and/or securing mechanisms) to securely and releasably hold the physical collectible item 105 (e.g., card) when docked by means of friction and/or gravity. A proximal face of the receptacle 210 (i.e., a portion of the receptacle facing away from the display dock 120) may be transparent so as to not obscure the artwork 110 printed on the physical collectible item 105. Alternatively, the depth of the receptacle 210 may be sufficiently shallow so as to not obscure the artwork 110 on the card 105 while still securely holding the card 105. The display dock 120 may be constructed from any suitable material, such as plastic (e.g., PET, HDPE, PVC, LDPE, PP, PC), metal, glass, or Plexiglass® (acrylic).

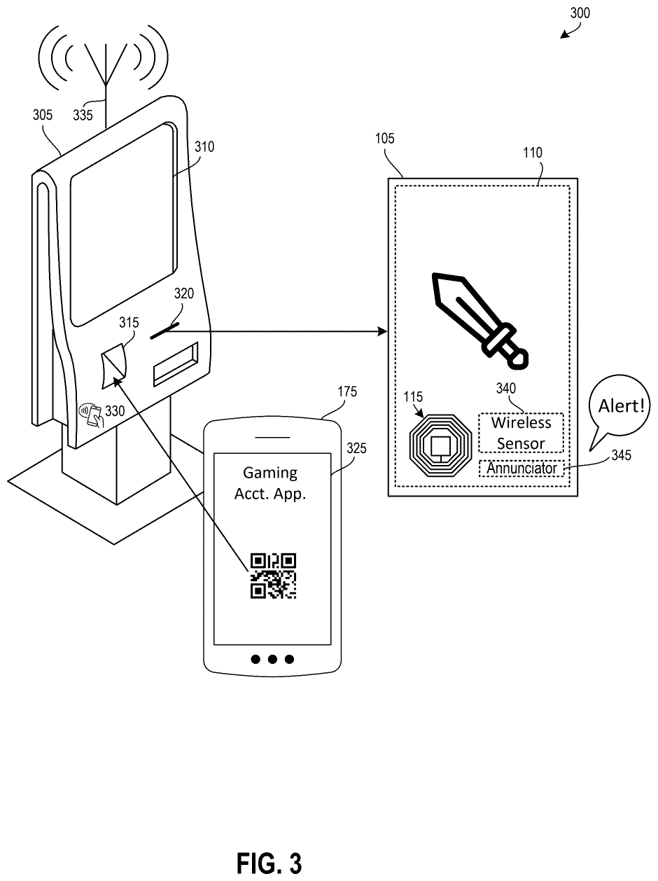

FIG. 3 illustrates an exemplary kiosk 305 where physical collectible items 105 may be obtained and registered with user accounts 145. Such a kiosk 305 may hold a number of new cards 105 that have been pre-printed with various artwork 110 associated with one or more video games. The kiosk 305 may include a touch-sensitive display 310 or other input/output component capable of displaying text, graphics, and video, and receiving user selections in response to the user selection of various graphical elements. The user may authenticate with the kiosk 305 by providing a user name and password via the touch-sensitive display 310.

Alternatively, the user may have previously authenticated with a gaming account application 325 (e.g., PSN application) running on a portable user device 175, such as a smart phone. Upon being authenticated on the user device 175, the gaming account application 325 may display a QR code, which may be read by a code scanner 315 (e.g., camera or laser scanner) within the kiosk 305. In other embodiments, the portable user device 175 may communicate with the kiosk 305 using a wireless communication technique, such as WiFi, NFC, or Bluetooth.

The user may then operate the touch-sensitive display 310 to view available cards 105 and/or entitlements. Some cards 105 may be pre-associated with unique codes 115 and particular entitlements, such as items, skins, or the like. Other cards 105 may have no pre-associated entitlements, and a user may select, via the touch-sensitive display 310, one or more entitlements to purchase and associate with a desired physical collectible item 105. By means of the touch-sensitive display 310, the user may also watch trailers or other descriptive videos or text describing the purchase options.

As an example, a user may wish to obtain a reward or entitlement 155, such as a particular sword for a video game that the user owns. The user selects a physical collectible item 105 having artwork 110 depicting the sword. The physical collectible item 105 may have been pre-associated with a embedded code 115 that, when added to the user account 145 of the authenticated user, will provide the sword to the user's character 185. Assuming that the kiosk 305 has a physical collectible item 105 in its inventory with the desired artwork 110, the kiosk 305 may retrieve the physical collectible item 105 and verify the embedded code 115 using a code reader (not shown) as described in connection with FIG. 1. Thereafter, the kiosk 305 may transmit the embedded code 115 to the interaction server 160 via the communication network 135, such that the embedded code 115 is stored as unique code 150 associated with the user account 145, as previously described, or the user is associated with the embedded code 115, i.e., the embedded code 115 becomes an account number or identifier to represent the user. The kiosk 305 may then issue the physical collectible item 105 to the user via a vending slot 320.

In some implementations, the user may already own a physical collectible item 105 depicting a character from a particular video game and want to register for a live, real-world event and/or associate a new reward, such as an in-game object, with the physical collectible item 105. In such an embodiment, the user may insert the physical collectible item 105 into the vending slot 320 and/or tap the physical collectible item 105 on a tap sensor 330, where the embedded code 115 is read. The user may then select the event or reward to be associated with the embedded code 115 and authenticate themselves in the same manner described herein. The primary difference is that a new physical collectible item 105 is not issued to the user. Rather, the user's physical collectible item 105, or more specifically, the embedded code 115 associated with the user's physical collectible item 105, is associated in the database 140 with the event registration and any associated rewards 155 (updated with any newly earned or purchased rewards or entitlements).

In some implementations, the physical collectible item 105, the display dock 120, or user device 175 may include a wireless sensor 340 and/or an annunciator 345. The wireless sensor 340 detects the proximity of a wireless transmitter 335 in the local environment as the user carries the docked physical collectible item 105. The annunciator 345 audibly or haptically notifies the user of the proximity of the wireless transmitter 335. Alternatively, or in addition, the integrated display 110 may function as an annunciator, graphically indicating that the wireless transmitter 335 is near. In some embodiments, the wireless sensor 340 may be implemented using the code reader 125 or the network interface 130 of the display dock 120, either of which may be configured to detect the existence (and strength) of certain RF signals.

As an example, the wireless transmitter 335 may be a Bluetooth® transmitter deployed in a kiosk 305. As the user moves about the local environment, the wireless sensor 340 (or code reader 125 or network interface 130) detects an RF transmission from the wireless transmitter 335. The content of the RF transmission may indicate that the detected wireless transmitter 335 is associated with a nearby kiosk 305. As a result, the physical collectible item 105 may be programmed to display a message, e.g., “ALERT: Kiosk nearby!” Alternatively or in addition, the annunciator 345 may be programmed to deliver a haptic response (vibration) or audible message (including a spoken message in some cases), notifying the user of the existence of the nearby kiosk 305.

As another example, the aforementioned components may be used to alert the user to the proximity of nearby rewards opportunities, each of whom may be associated with a real-world object, location, person, or action(s). For example, a network interface 130 embedded in a real-world objects (e.g., including artwork, sculpture, or props associated with a particular game or other media title or theme) may serve as wireless transmitters 335. As the user moves about the local environment, the wireless sensor 340 (or code reader 125 or network interface 130) detects an RF transmission from the wireless transmitters 335 (or network interfaces 130). The RF transmission may include a code that identifies the object and associated media. If the media title is one played by the user or for which the user has expressed interest, the user's physical collectible item 105 may be programmed to display a message, e.g., “ALERT: Game Reward nearby!” Alternatively or in addition, the annunciator 345 may be programmed to deliver a haptic response (vibration) or audible message (including a spoken message in some cases), notifying the user of the existence of the nearby reward.

Alternatively, the aforementioned components may be used in the context of a scavenger hunt, at a convention (e.g., ComicCon™), or in other ways where it is necessary or useful to alert the user to the existence of an item, person, or information in their vicinity marked by respective wireless transmitters 335. In some embodiments, the user may receive achievements or trophies or certain rewards 155 in response to visiting a real-word location marked by a wireless transmitter 335, which could be reflected on the display 110 of the physical collectible item 105. In some implementations, the respective user devices 175 of each user and peer/friend may serve to perform one or more functions of the wireless transmitter 335, as well as wireless sensor 340 and annunciator 345, as described herein.

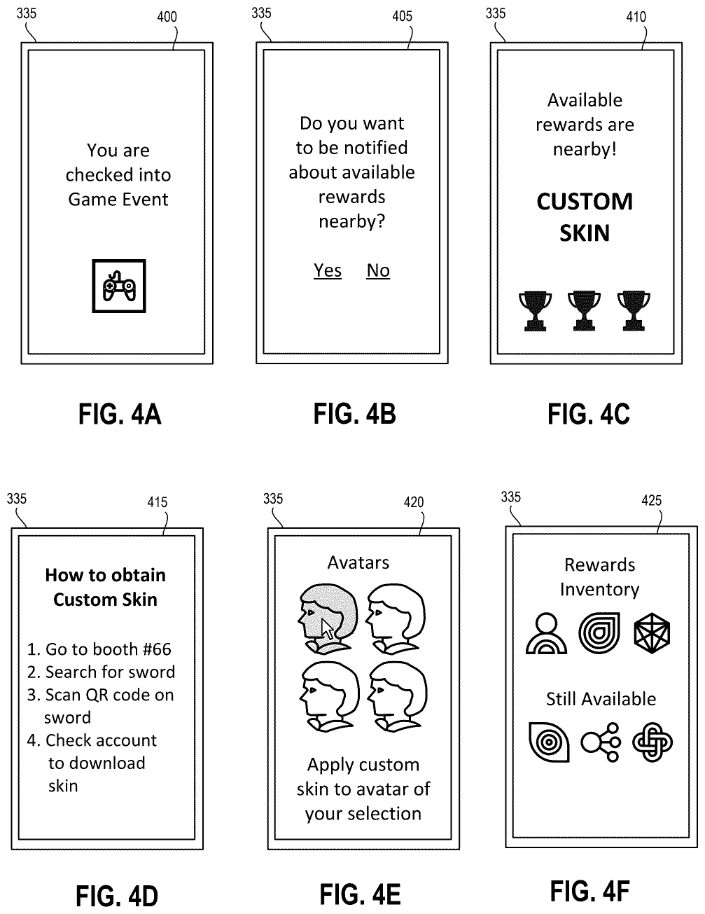

FIGS. 4A-F illustrate exemplary screenshots of graphical user interfaces (GUIs) 400-425 that may be presented on a display 325 as user engagement is tracked across real-world and digital environments. Such GUIs 400-425 may be presented by a user's respective display 325 of display dock 120 (or user device 175) once their respective physical collectible item 105 has been obtained and their respective unique code 150 registered with and stored in relation to their respective user account 145. The users may also opt to allow interaction server 165 to send notifications based on detection of their real-world proximity to rewards on a short-term, temporary or ongoing basis.

FIG. 4A illustrates a GUI 400 that may be presented when a user has obtained their physical collectible item 105 and checked into an event (e.g., gaming convention, real-world gameplay session) in a real-world environment. GUI 400 may include event or media title branding and associated display content, as well as allow for access to information regarding the event or media title.

FIG. 4B illustrates a GUI 405 that may be presented when the user is allowed to opt in or opt out of notifications based on detected presence in the real-world environment and proximity to available rewards. Each user may be permitted to specify their own privacy settings in relation to location sharing and communications, but may also be informed as to various rewards, incentives, and entitlements that may be earned, won, or otherwise obtained based on real-world interactions, which may be facilitated through location sharing.

FIG. 4C illustrates a GUI 410 that may be presented when a user is notified as to the presence of an available reward opportunity based on real-world action within a predetermined proximity (e.g., corresponding to device capabilities of wireless sensor 340). GUI 410 may identify the particular reward 155 if the user were to find and interact with the detected interaction opportunity or peer in the real-world environment.

FIG. 4D illustrates a GUI 415 that may be presented when the user seeks to satisfy the requirements of earning the reward 155. GUI 415 may provide instructions for how the reward 155 is to be earned and obtained. Such instructions may be based on stored rules 160 associated with the particular reward 155 being offered by FIG. 4C.

FIG. 4E illustrates a GUI 420 that may be presented when the user is determined to be associated with multiple different media titles and/or avatars. GUI 420 may be generated based on user account 145 data regarding the user's gameplay history or game library with whom the user may have interacted in digital environments during online gameplay sessions in relation to one or more interactive content titles. The list of titles or avatars may be filtered based on the context of the event (e.g., esports tournament for specific game title or titles).

FIG. 4F illustrates a GUI 425 that may be presented when the user is determined to have earned or won certain rewards, while other rewards remain outstanding and yet to be won. GUI 425 may be updated in real-time as the user earns additional rewards based on associated requirements being satisfied by the user's real-world interactions as specified by stored rules 160.

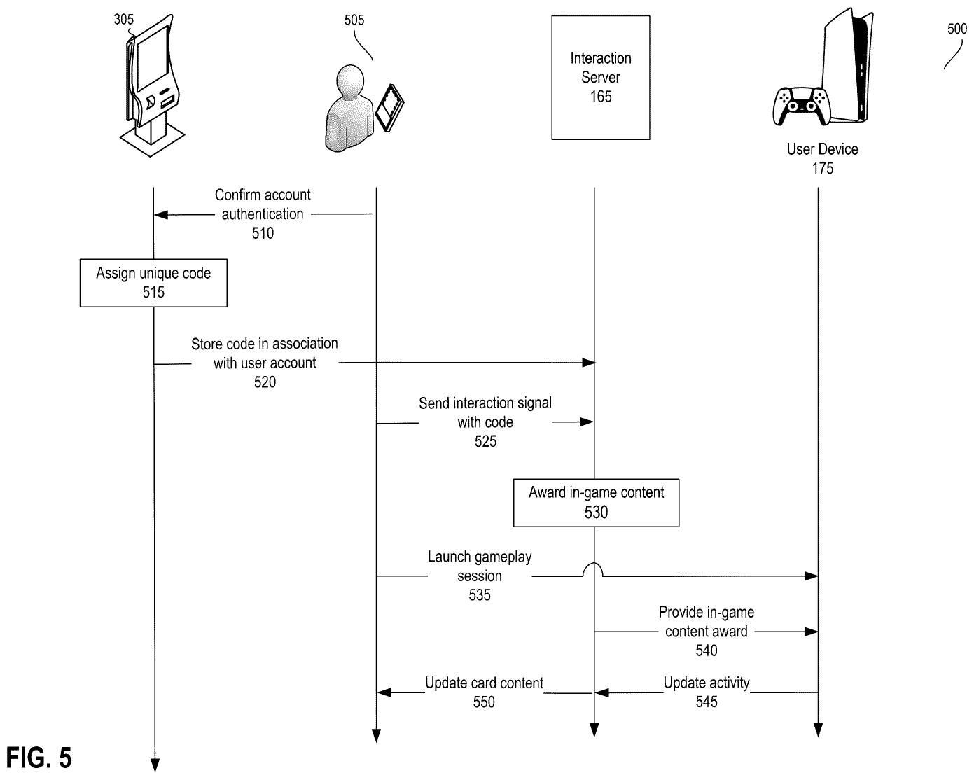

FIG. 5 is a swimlane diagram 500 illustrating an exemplary implementation of a system for generating and modifying in-game content based on real-world interactions. As illustrated, the implementation may involve use and/or participation by a kiosk 305, user 505 that has been issued physical collectible item 105, interaction server 165, and user device 175 (e.g., game console) used to engage in gameplay sessions.

In step 510, the user may provide user account data (e.g., credentials) and thus authenticate themselves to the kiosk 305 as the individual associated with a specific suer account 145. As discussed herein, the user account 145 may be the same one used to engage in gameplay within virtual environments during gameplay sessions established with user device 175.

In step 515, the kiosk 305 may assign a unique code 150 to the authenticated user account 145. The unique code 150 may have been pre-generated or generated at the kiosk and associated with an existing or new physical collectible item 105. For example, the kiosk 305 may dispense a new physical collectible item 105 known to be associated with the unique code. Alternatively, where the user 505 may already have an existing physical collectible item 105 that is not already associated with a unique code 150, the kiosk 305 may embed the unique code 150 (e.g., by printing a QR code, encoding a chip).

In step 520, the unique code 150 may be provided to interaction server 165 to store in association with the authenticated user account 145. The interaction server 165 may then either store in a local or remote database 140, which may also store data regarding other user accounts 145 and corresponding unique codes 150. As signals are sent to interaction server 165, the interaction server 165 may identify whether each signal includes a code that matches one of the unique codes 150 stored in the database 140.

In step 525, the user 505—having been issued a unique code 150 embedded in a physical collectible item 105—may initiate transmission of an interaction signal 525 from either the physical collectible item 105 itself, associated display dock 120, or mobile user device 175 (e.g., mobile phone). The interaction signal 525 may include the unique code 150 assigned to the user account 145 of the user, as well as data regarding a real-world action or interaction.

In step 530, the interaction server 165 may evaluate the unique code 145 to identify the associated user account 145, as well as determine whether the data regarding the real-world action meets the requirements of a digital reward 155. Where the requirements of a digital reward 155 are identified as having been met, the interaction server 165 may store the digital reward 155 in the database 140 in association with the identified user account 145. In some implementations, multiple different rewards 155 may be available to e won or redeemed based on the real-world action. The interaction server 165 may allow the user to select from among the different rewards 155 or randomly select one from among the different rewards 155.

In step 535, the user may launch a gameplay session on user device 175 using user account 145, and in step 540, the interaction server 165 may provide the content associated with the digital rewards 155 to the user device 175 for presentation within the virtual environment of the gameplay session. Presentation may include applying to a particular avatar or in-game object associated with the user account 145, or executing instructions associated with an in-game ability.

Some implementations allow for gameplay data from user device 175 to be used in step 545 to update an activity or associated progress level towards a reward. For example, the user may achieve an in-game objective, which may be used by interaction server 165 to update reward content (e.g., badges, trophies) or progress towards additional rewards content.

Ins step 550, interaction server 165 may update card content associated with the physical collectible item 105, which may include providing the updated content to the physical collectible item 105 itself or associated display dock 120.

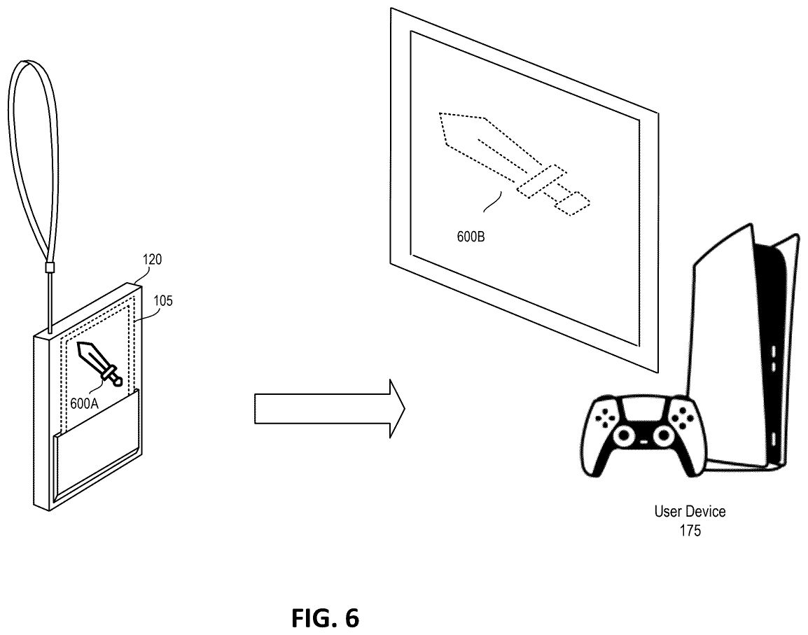

FIG. 6 illustrates an exemplary reward of digital content provided within a digital environment. In particular, FIG. 6 illustrates the transfer of digital content 600A associated with physical collectible item 105A and display dock 120A to user device 175, which may be inclusive of an entertainment system capable of rendering virtual environment displays and presenting the associated content 600B of the digital content therein. Such transfer may be accomplished by physically or communicatively connecting the physical collectible item 105A or display dock 120A to the user device 175. The embedded code 115 of the physical collectible item 105A may be sent to the interaction server 160, which may match the embedded code 115 to the unique code 150 of a user account 145 in the database 140. The digital content 600A—which may be or associated with a digital reward 155—may thus be provided to user device 175 and presented as digital content 600B in association with the gameplay session. For example, the digital content 600B may include an in-game sword associated with a particular game title, which may therefore be used by the user account 145 (e.g., via associated avatar 185) within a virtual environment 180 of that game title during a next gameplay session. While the content 600A associated with physical collectible item 105 is illustrated in FIG. 6 as having a similar appearance to in-game content 600B, such similarity is not a requirement. Content 600A of the physical collectible item 105 may merely be an indicator, from the same or associated title, or have no relationship (e.g., randomly assigned, surprise, loot box) to in-game content 600B.

In some implementations, the user may be prompted via, e.g., a text or email message, to authenticate themselves (e.g., via PIN or password), as well as to select what title or avatar the content 700A should be applied to in the virtual environment. For example, the physical collectible item 105 and any associated reward 155 may be locked to prevent theft of the rewards 155 or content 700A if the physical collectible item 105 is lost or stolen. Providing the password or PIN, for example, may allow the rewards 155 or content 600A to be used securely by user account 145 on different user devices 175.

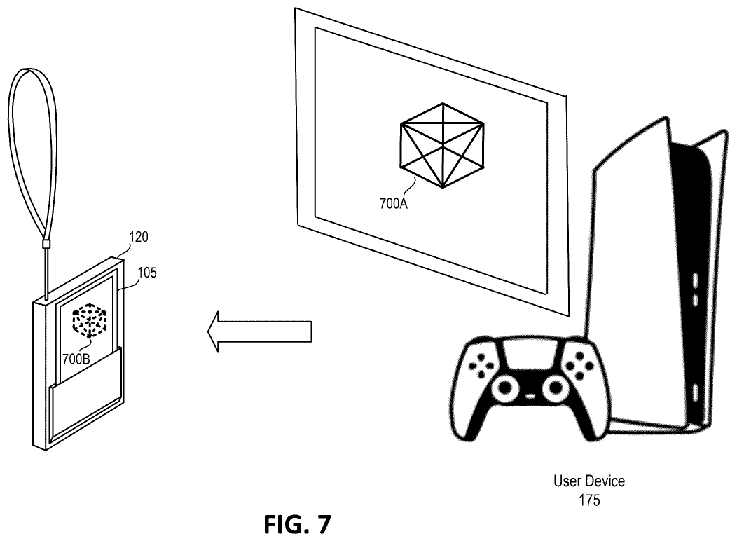

FIG. 7 illustrates an exemplary update to digital content 700A provided from a digital environment. In particular, the digital content 700A may be provided from user device 175 to the physical collectible item 105A. In some implementations, gameplay may result in changes to existing digital content or generation of new digital content 700A, which may be used to update content 700B presented by the physical collectible item 105 or associated display dock 120. The physical collectible item 105 or display dock 120 may be identified, for example, by being brought into proximity with user device 175; in such instances, a wireless sensor 340 (or the code reader 125 or network interface 130) associated with the user may detect the proximity between the physical collectible item 105 and/or display dock 120 and the user device 175, which may also determine that the user account 145 of the user being used to engage in gameplay is also associated with the physical collectible item 105 or display dock 120. A copy or modified version 700B (e.g., associated artwork) of the content 700A may thus be provided to physical collectible item 105 or display dock 120 for display thereon. Whereas content 700A may be associated with in-game abilities, for example, a more streamlined file that includes associated artwork 700B may be provided to physical collectible item 105 or display dock 120. Certain media titles may be associated with multiple different pieces of digital artwork, which may be distributed at various times for collecting by fans and users through the physical collectible item 105. As a user acquires and adds artwork to their collection associated with user account 145, different artwork may also be provided to physical collectible item 105 or display dock 120 for display.

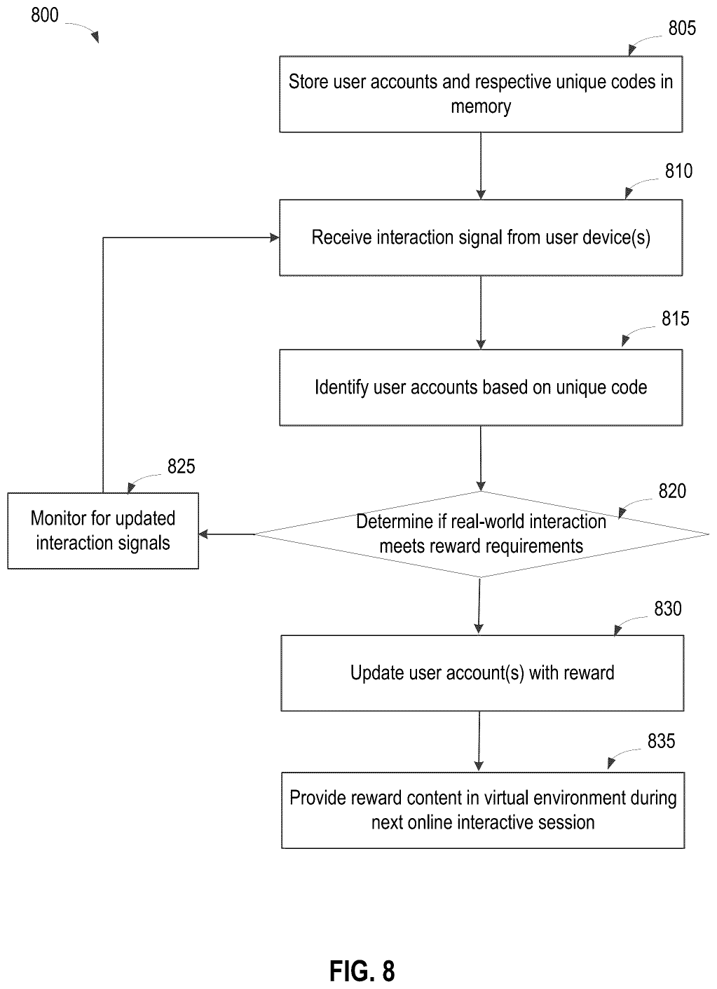

FIG. 8 is a flowchart illustrating an exemplary method 800 for generating and modifying in-game content based on real-world interactions. The method 800 of FIG. 8 may be embodied as executable instructions in a non-transitory computer readable storage medium including but not limited to a CD, DVD, or non-volatile memory such as a hard drive. The instructions of the storage medium may be executed by a processor (or processors) to cause various hardware components of a computing device hosting or otherwise accessing the storage medium to effectuate the method. The steps identified in FIG. 8 (and the order thereof) are exemplary and may include various alternatives, equivalents, or derivations thereof including but not limited to the order of execution of the same.

The method 800 begins with step 805, in which user accounts 145 are stored in a database 140 in memory. A user account 145 may be updated to include stored information regarding a unique code 150 assigned to the user of the user account 145 when the user obtains and registers a physical collectible item 105. Registration allows for the embedded code 115 of the physical collectible item 105 to be provided to database 140 for storage in association with the user account 145 that is also used to engage in gameplay on online gaming platforms (e.g., including one or more game servers 170).

In step 810, one or more interaction signals may be received from one or more sources, which may be inclusive of physical collectible item 105, display dock 120, or user device 175 associated with a particular user. The interaction signal may include not only the unique code 150 of the user owning such devices, but also interaction data (e.g., scan, read, or image of an embedded code 115 on a real-world object or physical collectible item 105 belonging to a peer). Such an interaction signal may also be generated, for example, when the user captures data regarding a real-world location, object, or person in association with unique code 150.

In step 815, the user account 145 may be identified by interaction server 165 from the specified unique code 150 in the received interaction signals, and in step 820, it is determined whether any rewards requirements are met by the real-world interaction indicated by the interaction signals. For example, if the user has already earned the reward or the predetermined maximum has been met, no further rewards may be available, and the method may proceed to step 825 in which the interaction server 165 may monitor for updated interaction signals.

If rewards requirements are determined to have been met, the method may proceed to step 830, where the respective user account 145 of the user may be updated to reflect the reward 155. For example, the user may be rewarded with a custom, special edition, or limited edition skin.

In step 835, the rewards 155 content may be provided for use by the user account 145 of the user within a virtual environment 180 during a next gameplay session. For example, the special edition skin may be provided in an inventory of the associated game title when the user launches gameplay, and upon selection, the special edition skin may be applied to the avatar 185 or in-game object associated with the user and displayed to other players in the launched (multiplayer) gameplay session established using user device 175.

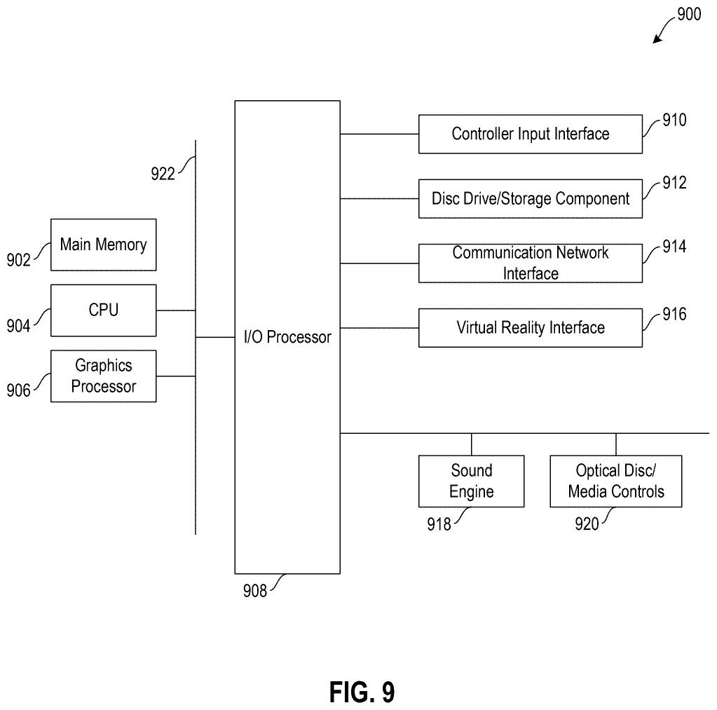

FIG. 9 illustrates a block diagram of an exemplary electronic entertainment system 900, which may be used to display and navigate the digital environment (e.g., game environment) shown in FIG. 2. The electronic entertainment system 900 as illustrated in FIG. 9 includes a main memory 902, a central processing unit (CPU) 904, graphic processor 906, an input/output (I/O) processor 908, a controller input interface 910, a hard disc drive or other storage component 912 (which may be removable), a communication network interface 914, a virtual reality interface 916, sound engine 918, and optical disc/media controls 920. Each of the foregoing are connected via one or more system buses 922.

Electronic entertainment system 900 as shown in FIG. 9 may be an electronic game console. The electronic entertainment system 900 may alternatively be implemented as a general-purpose computer, a set-top box, a hand-held game device, a tablet computing device, or a mobile computing device or phone. Electronic entertainment systems may contain some or all of the disclosed components depending on a particular form factor, purpose, or design.

Main memory 902 stores instructions and data for execution by CPU 904. Main memory 902 can store executable code when the electronic entertainment system 900 is in operation. Main memory 902 of FIG. 9 may communicate with CPU 904 via a dedicated bus.

Main memory 902 may provide pre-stored programs in addition to programs transferred through the I/O processor 908 from hard disc drive/storage component 912, a DVD or other optical disc (not shown) using the optical disc/media controls 920, or as might be downloaded via communication network interface 914.

The graphics processor 906 of FIG. 9 (or graphics card) executes graphics instructions received from the CPU 904 to produce images for display on a display device (not shown). The graphics processor 906 of FIG. 9 may transform objects from three-dimensional coordinates to two-dimensional coordinates, and vice versa. Graphics processor 906 may use ray tracing to aid in the rendering of light and shadows in a game scene by simulating and tracking individual rays of light produced by a source. Graphics processor 906 may utilize fast boot and load times, 4K-8K resolution, and up to 120 FPS with 120 hz refresh rates. Graphics processor 906 may render or otherwise process images differently for a specific display device.

I/O processor 908 of FIG. 9 may also allow for the exchange of content over a wireless or other communications network (e.g., IEEE 802.x inclusive of Wi-Fi and Ethernet, 9G, 4G, LTE, and 3G mobile networks, and Bluetooth and short-range personal area networks). The I/O processor 908 of FIG. 9 primarily controls data exchanges between the various devices of the electronic entertainment system 900 including the CPU 904, the graphics processor 906, controller interface 910, hard disc drive/storage component 912, communication network interface 914, virtual reality interface 916, sound engine 918, and optical disc/media controls 920.

A user of the electronic entertainment system 900 of FIG. 9 provides instructions via a controller device communicatively coupled to the controller interface 910 to the CPU 904. A variety of different controllers may be used to receive the instructions, including handheld and sensor-based controllers (e.g., for capturing and interpreting eye-tracking-based, voice-based, and gestural commands). Controllers may receive instructions or input from the user, which may then be provided to controller interface 910 and then to CPU 904 for interpretation and execution. The instructions may further be used by the CPU 904 to control other components of electronic entertainment system 900. For example, the user may instruct the CPU 904 to store certain game information on the hard disc drive/storage component 912 or other non-transitory computer-readable storage media. A user may also instruct a character in a game to perform some specified action, which is rendered in conjunction with graphics processor 906, inclusive of audio interpreted by sound engine 918.

Hard disc drive/storage component 912 may include removable or non-removable non-volatile storage medium. Saud medium may be portable and inclusive of digital video disc, Blu-Ray, or USB coupled storage, to input and output data and code to and from the main memory 902. Software for implementing embodiments of the present invention may be stored on such a medium and input to the main memory via the hard disc drive/storage component 912. Software stored on a hard disc drive may also be managed by optical disk/media control 920 and/or communications network interface 914.

Communication network interface 914 may allow for communication via various communication networks, including local, proprietary networks and/or larger wide-area networks such as the Internet. The Internet is a broad network of interconnected computers and servers allowing for the transmission and exchange of Internet Protocol (IP) data between users connected through a network service provider. Examples of network service providers include public switched telephone networks, cable or fiber services, digital subscriber lines (DSL) or broadband, and satellite services. Communications network interface allows for communications and content to be exchanged between the various remote devices, including other electronic entertainment systems associated with other users and cloud-based databases, services and servers, and content hosting systems that might provide or facilitate game play and related content.

Virtual reality interface 916 allows for processing and rendering of virtual reality, augmented reality, and mixed reality data. This includes display devices such that might be partial or entirely immersive virtual environments. Virtual reality interface 916 may allow for exchange and presentation of immersive fields of view and foveated rendering in coordination with sounds processed by sound engine 918 and haptic feedback.

Sound engine 918 executes instructions to produce sound signals that are outputted to an audio device such as television speakers, controller speakers, stand-alone speakers, headphones, or other head-mounted speakers. Different sets of sounds may be produced for each of the different sound output devices. This may include spatial or three-dimensional audio effects.

Optical disc/media controls 920 may be implemented with a magnetic disk drive or an optical disk drive for storing, managing, and controlling data and instructions for use by CPU 904. Optical disc/media controls 920 may be inclusive of system software (an operating system) for implementing embodiments of the present invention. That system may facilitate loading software into main memory 902.

The systems and methods described herein can be implemented in hardware, software, firmware, or combinations of hardware, software and/or firmware. In some examples, systems described in this specification may be implemented using a non-transitory computer readable medium storing computer executable instructions that when executed by one or more processors of a computer cause the computer to perform operations. Computer readable media suitable for implementing the control systems described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer readable medium that implements a control system described in this specification may be located on a single device or computing platform or may be distributed across multiple devices or computing platforms.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

What is claimed is:

1. A method for generating in-game content based on real-world interactions, the method comprising:
storing information in memory regarding one or more user accounts each associated with a respective unique code, wherein each user account includes information regarding one or more gameplay sessions established in connection with the user account;
receiving an interaction signal sent over a communication network, wherein the interaction signal includes a unique code and data regarding a real-world action taking place in a real-world environment;
identifying one of the user accounts that is associated with the unique code in the interaction signal;
determining that the real-world action data meets one or more requirements associated with a digital reward; and
generating content associated with the digital reward based on the real-world action data, wherein the generated content is configured to be presented within a virtual environment in a next gameplay session established in connection with the identified user account.

2. The method of claim 1, further comprising storing information in memory regarding a plurality of different digital rewards, each of the different digital rewards associated with a different set of one or more requirements regarding one or more real-world actions.

3. The method of claim 1, further comprising combining the generated content with pre-existing content associated with the identified user account, wherein the generated content is presented in combination with the pre-existing content associated with the identified user account within the virtual environment.

4. The method of claim 3, wherein the pre-existing content includes content associated with one or more previous digital rewards associated with the user account.

5. The method of claim 4, wherein a different user account is associated with different pre-existing content, and wherein combining the generated content with different pre-existing content associated with the different user account results in a different combination being presented within the virtual environment.

6. The method of claim 1, wherein the generated content includes instructions regarding one or more in-game abilities, and wherein presenting the generated content within the virtual environment includes performing one or more of the in-game abilities in response to trigger input by the identified user account.

7. The method of claim 6, wherein the in-game abilities are specific to one or more game titles associated with the identified user account, and further comprising receiving a selection of one of the game titles, wherein the virtual environment in which the in-game abilities are presented is associated with the selected game title.

8. The method of claim 6, wherein the in-game abilities are specific to one or more avatars associated with the identified user account, and further comprising receiving a selection of one of the avatars, wherein the in-game abilities are presented as being performed by the avatar.

9. The method of claim 1, wherein the requirements associated with the digital reward specify one or more parameters for the real-world action, and wherein determining that the real-world action data meets the requirements is based on matching detected parameters of the real-world action to the parameters specified by the requirements.

10. The method of claim 9, wherein the real-world action includes capturing an image of a real-world environment, and wherein matching the detected parameters of the real-world action to the parameters specified by the requirements includes matching the captured image to stored data regarding the real-world environment.

11. The method of claim 9, wherein the real-world action includes capturing an image of a real-world object, and wherein matching the detected parameters of the real-world action to the parameters specified by the requirements includes matching the captured image to stored data regarding the real-world object.

12. The method of claim 9, wherein the real-world action includes a physical movement, and wherein the specified parameters characterize the physical movement.

13. The method of claim 9, wherein the real-world action includes capturing a short-range signal, and wherein matching the detected parameters of the real-world action to the parameters specified by the requirements is based on a confirmation that the short-range signal is captured by a user device associated with the identified user account.

14. The method of claim 1, further comprising receiving a request over a communication network from a user device associated with the identified user account, the request regarding available digital rewards; and performing a search for one or more available digital rewards associated with a location of the user device.

15. The method of claim 1, wherein generating the content associated with the digital reward is further based on user data specified by the identified user account, and wherein the content generated for the user account is different than content generated for a different user account specifying a different type of user data.

16. The method of claim 1, further comprising customizing the generated content associated with the digital reward based on customization input associated with the identified user account.

17. The method of claim 1, wherein the digital reward is associated with a predetermined maximum, and wherein determining that the real-world action data meets the requirements associated with the digital reward includes determining that the predetermined maximum has not yet been met.

18. The method of claim 17, further comprising determining that the predetermined maximum has been met in response to a subsequent interaction signal associated with a different user account, and determining whether the subsequent interaction signal meets one or more requirements associated with a different digital reward having a predetermined maximum that has not yet been met.

19. The method of claim 1, wherein the real-world action data is determined to meet the requirements associated with a plurality of different digital rewards, and further comprising prompting the identified user account to select from among the determined digital rewards, wherein the generated content is based on the selected digital reward.

20. A non-transitory computer-readable storage medium, having embodied thereon a program executable by a processor to perform a method for generating in-game content based on real-world interactions, the method comprising:
storing information in memory regarding one or more user accounts each associated with a respective unique code, wherein each user account includes information regarding one or more gameplay sessions established in connection with the user account;
receiving an interaction signal sent over a communication network, wherein the interaction signal includes a unique code and data regarding a real-world action taking place in a real-world environment;
identifying one of the user accounts that is associated with the unique code in the interaction signal;
determining that the real-world action data meets one or more requirements associated with a digital reward; and
generating content associated with the digital reward based on the real-world action data, wherein the generated content is configured to be presented within a virtual environment in a next gameplay session established in connection with the identified user account.
